(19) United States
(12) Patent Application Publication
(10) Pub. No.: US 2026/0178601 A1
(43) Pub. Date: Jun. 25, 2026

(54) DATABASE MANAGEMENT APPARATUS AND DATABASE MANAGEMENT METHOD

(71) Applicant: Hitachi, Ltd., Tokyo (JP)

(72) Inventors: Norifumi NISHIKAWA, Tokyo (JP); Shinji FUJIWARA, Tokyo (JP)

(21) Appl. No.: 19/305,577

(22) Filed: Aug. 20, 2025

(30) Foreign Application Priority Data
Dec. 23, 2024 (JP) 2024-226772

(51) Int. Cl. G06F 16/25; G06F 7/06; G06F 16/2455

(52) U.S. Cl. CPC G06F 16/25; G06F 7/06; G06F 16/2455

(57) ABSTRACT

A database management apparatus specifies one or more pages in which a difference between a maximum and a minimum value of key values is equal to or larger than a threshold, the one or more pages being a part of a B-tree index corresponding to the chunk. The database management apparatus splits a page that includes a maximum and a minimum value of key values into a page that includes a maximum value and a page that includes a minimum value, sorts a plurality of pages including pages obtained by splitting each of the one or more pages in accordance with magnitudes of a plurality of key values of a plurality of instances, and constructs one B-tree index including the sorted pages as a B-tree index after merge of a plurality of B-tree indexes corresponding to the plurality of chunks to be merged.

### CROSS-REFERENCE TO PRIOR APPLICATION

This application relates to and claims the benefit of priority from Japanese Patent Application number 2024-226772, filed on Dec. 23, 2024 the entire disclosure of which is incorporated herein by reference.

### BACKGROUND

The present invention relates generally to database management.

Some databases are constructed such that data is imported continuously or intermittently (for example, every given period of time). Examples of such databases include databases used in manufacturing industries and healthcare businesses.

A logical data area called “chunk” is created each time data is imported, and data is imported in the area. When the index of a database is a B-tree index, a B-tree index is created for each chunk.

The performance of search using the B-tree index becomes lower as the number of chunks increases. The reason is that when the number of chunks is large, the number of B-tree indexes to be searched is also large.

By using a condition related to search or join so as to filter chunks, the number of B-tree indexes to be referenced can be reduced. However, the number of times of checks as to whether a chunk includes data that satisfies the condition related to search or join is proportional to the number of chunks, and hence the possibility that search performance improves is low.

Thus, as a method with which search performance is expected to improve, chunk merge for combining a plurality of chunks into a single chunk is conceivable. The chunk merge includes index merge for combining a plurality of B-tree indexes into a single B-tree index.

In regard to merge of B-tree indexes or partitioned B-trees, for example, the technologies disclosed in U.S. Pat. Nos. 6,694,323, 9,262,458, and 9,298,761 are known. Furthermore, in regard to merge of partitions in a database, for example, the technologies disclosed in U.S. Pat. Nos. 11,238,019, 9,489,411, and 7,987,164 are known.

### SUMMARY

Chunk merge includes index merge, which is merge of a plurality of B-tree indexes corresponding to a plurality of chunks to be merged. The execution of index merge needs a reasonable amount of time and resources.

For example, in manufacturing industries, one chunk includes a key value of each of a plurality of products (for example, data on history such as processing). The reason is that a plurality of products are manufactured within a given period of time. Key values of a plurality of products manufactured within a given period of time are stored in one chunk. Then, the number of chunks increases as time elapses. In other words, a chunk is added at regular time intervals. If all key values in each of chunks to be merged are sorted for index merge, the number of times of processing such as recreation of key values and copying of data is large and processing load is high.

Such a problem may arise in other databases in place of or in addition to databases used in manufacturing industries.

A database management apparatus according to one aspect of the present invention specifies, for each of a plurality of chunks to be merged, one or more pages in which a difference between a maximum value and a minimum value of key values is equal to or larger than a threshold, the one or more pages being a part of pages in a B-tree index corresponding to the chunk. The database management apparatus splits, for each of the one or more specified pages, a page that includes a maximum value and a minimum value of key values into a page that includes a maximum value of a key value and a page that includes a minimum value of a key value, sorts a plurality of pages including pages obtained by splitting each of the one or more pages in accordance with magnitudes of a plurality of key values of a plurality of instances, and constructs one B-tree index including the sorted pages as a B-tree index after merge of a plurality of B-tree indexes corresponding to the plurality of chunks to be merged.

According to the present invention, processing load necessary for index merge of a plurality of B-tree indexes corresponding to a plurality of chunks in a database can be reduced.

### BRIEF DESCRIPTION OF THE DRAWINGS

FIG. 1 illustrates a configuration example of an overall system of a database management apparatus according to an embodiment;

FIG. 2 illustrates a configuration example of the database management apparatus;

FIG. 3 illustrates a configuration example of a database;

FIG. 4 schematically illustrates the outline of leaf pages with a B-tree index;

FIG. 5 schematically illustrates a part of the outline of chunk merge;

FIG. 6 schematically illustrates the remaining of the outline of chunk merge;

FIG. 7 illustrates a configuration example of a DB element management table;

FIG. 8 illustrates a configuration example of an index details table;

FIG. 9 illustrates a configuration example of a condition management table;

FIG. 10 illustrates a flow example of page unit merge;

FIG. 11 schematically illustrates an example of a situation or processing in a flow of page unit merge;

FIG. 12 illustrates a flow example of S14 in FIG. 10;

FIG. 13 illustrates a flow example of subtree unit merge;

FIG. 14 schematically illustrates an example of a situation or processing in a flow of subtree unit merge;

FIG. 15 illustrates a flow example of S34 in FIG. 13;

FIG. 16 illustrates a flow example of S35 in FIG. 13;

FIG. 17 illustrates a flow example of page unit merge according to a modification; and

FIG. 18 illustrates a flow example of subtree unit merge according to a modification.

### DESCRIPTION OF THE PREFERRED EMBODIMENTS

In the following description, an “interface apparatus” may be one or more interface devices. The one or more interface devices may be at least one of one or more input/output (I/O) interface devices and one or more communication interface devices. Each of the one or more input/output (I/O) interface devices may be an interface device for at least one of an I/O device and a remote display computer. The I/O interface device for the display computer may be a communication interface device. The at least one I/O device may be any one of a user interface device, for example, an input device such as a keyboard and a pointing device, and an output device such as a display device. The one or more communication interface devices may be the same type of one or more communication interface devices (for example, one or more network interface cards (NICs)), or may be two or more different types of communication interface devices (for example, NIC and host bus adapter (HBA)).

Furthermore, in the following description, a “memory” is one or more memory devices as an example of one or more storage devices, and may be typically a main storage device. At least one memory device in the memory may be a volatile memory device or a non-volatile memory device.

Furthermore, in the following description, a “persistent storage apparatus” may be one or more persistent storage devices as an example of one or more storage devices. The persistent storage device may be typically a non-volatile storage device (for example, auxiliary storage device), and specifically, for example, may be a hard disk drive (HDD), a solid state drive (SSD), or a non-volatile memory express (NVMe) drive.

Furthermore, in the following description, a “processor” may be one or more processor devices. At least one processor device may be typically a microprocessor device such as a central processing unit (CPU), or may be another type of processor device such as a graphics processing unit (GPU). At least one processor device may be a single core processor or a multi-core processor. At least one processor device may be a processor core. At least one processor device may be a processor device in a broad sense, such as a hardware circuit for performing a part or whole of processing (for example, field-programmable gate array (FPGA), complex programmable logic device (CPLD), or application specific integrated circuit (ASIC)).

Furthermore, in the following description, a function is sometimes described in the form of “yyy unit”, but the function may be implemented when one or more computer programs are executed by a processor, may be implemented by one or more hardware circuits (for example, FPGA or ASIC), or may be implemented by a combination thereof. When a function is implemented when a program is executed by a processor, predetermined processing is performed as appropriate by using a storage apparatus and/or an interface apparatus, and hence the function may be at least a part of the processor. Processing that is described with a function as a subject may be processing performed by a processor or an apparatus having the processor. A program may be installed from a program source. The program source may be, for example, a program distributing computer or a computer-readable storage medium (for example, non-transitory storage medium). Descriptions of functions are illustrative. A plurality of functions may be integrated as one function, or one function may be divided into a plurality of functions.

Furthermore, in the following description, common symbols among reference symbols are sometimes used when the same type of elements are described with no distinction, and reference symbols (or identification numbers of elements) are sometimes used when the same type of elements are described while being distinguished.

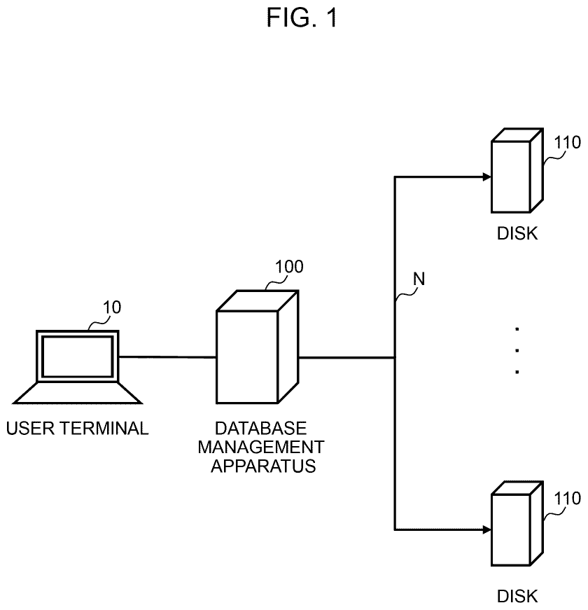

FIG. 1 illustrates a configuration example of an overall system including a database management apparatus 100 according to an embodiment.

The database management apparatus 100 is an apparatus capable of enabling efficient chunk merge. The database management apparatus 100 is coupled to a user terminal 10 and a disk 110 through a network N as necessary in a cooperative manner. Note that the database management apparatus 100 may include at least the disk 110 of the user terminal 10 and the disk 110 in its system configuration. The disk 110 may be an example of a persistent storage apparatus, or may be an example of an apparatus including a persistent storage apparatus. The user terminal 10 may be a physical computer such as a personal computer, or may be a virtual computer based on a physical computer. The network N may be the Internet, a local area network (LAN), a wide area network (WAN), or a cellular network.

The database management apparatus 100 is a computer system that is physically configured on a single computer or logically or physically configured on a plurality of computers, and may operate on a virtual computer configured on a plurality of physical computer resources. The database management apparatus 100 may be configured on a cloud, or may be an on-premises device configured on a particular computer (hardware).

A database is stored in the disk 110. A database may be stored in a single disk 110 or may be stored across a plurality of disks 110.

The user terminal 10 may transmit a request of import of data including values observed in a manufacturing line, for example, to the database management apparatus 100 through the network N at regular time intervals. A source of data to be imported may be an apparatus other than the user terminal 10 or a program. The source of data to be imported may be application executed inside or outside the database management apparatus 100.

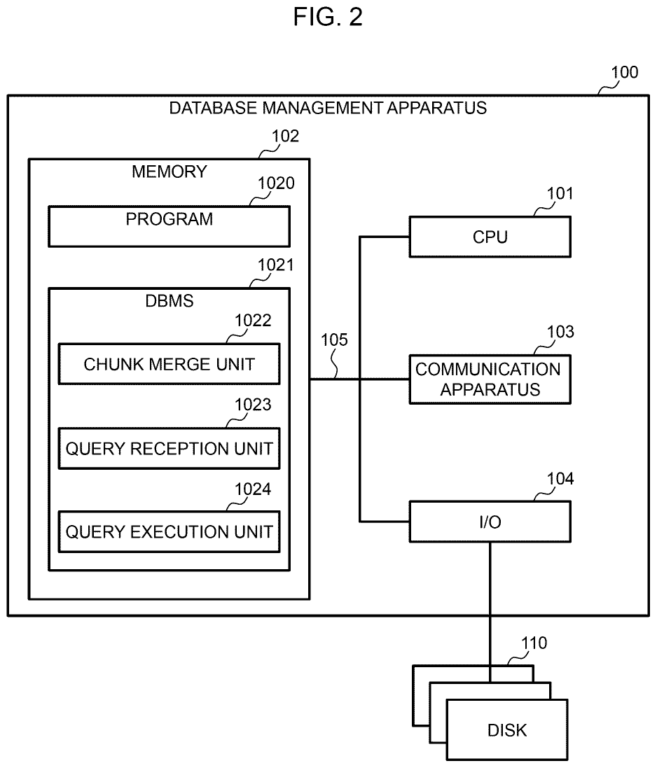

FIG. 2 illustrates a configuration example of the database management apparatus 100.

The database management apparatus 100 has a configuration in which a CPU 101, a memory 102, a communication apparatus 103, and an I/O 104 are coupled by a bus 105.

The communication apparatus 103 and the I/O 104 are examples of an interface apparatus. The communication apparatus 103 is coupled to the network N to communicate with the user terminal 10. The I/O 104 accesses an external device such as the disk 110 through the network N. Note that the user terminal 10 coupled to the database management apparatus 100 through the network N and the communication apparatus 103 may provide an input apparatus and an output apparatus (what is called user interface apparatus) through the I/O 104.

The memory 102 stores one or a plurality of computer programs therein. When these programs are executed by the CPU 101, a database management system (DBMS) 1021 is implemented. The DBMS 1021 has functions of a chunk merge unit 1022, a query reception unit 1023, and a query execution unit 1024.

The query reception unit 1023 receives a query for a database from the user terminal 10. The query is written in, for example, structured query language (SQL). The user terminal 10 may be an example of a query source (in other words, source of data to be imported to database).

The query execution unit 1024 may create, on the basis of a query received by the query reception unit 1023, a query plan necessary for executing the query. The query plan may be information including, for example, one or more database operators and a relation of execution order of the database operators. The query plan may be expressed by, for example, a tree structure in which database operators are nodes and the relation of execution order of the database operators is an edge. The query execution unit 1024 executes a query on the basis of the created query plan, and returns an execution result of the query to the user terminal 10. In the execution of the query, the query execution unit 1024 creates a task for executing a database operator, and executes the created task, thereby issuing a read request (or write request) of data necessary for the database operator corresponding to the task. The query execution unit 1024 may execute a plurality of database operators by one task. A task may be implemented by using, for example, a user thread implemented by a library, in addition to a process or a kernel thread implemented by an operating system (OS) (not shown). The query plan is not necessarily required for the execution of a query. For every import of data to the database, in response to a query of the import, the query execution unit 1024 stores data to be imported in a chunk corresponding to the import, and construct a B-tree index corresponding to the chunk.

The chunk merge unit 1022 performs chunk merge described later.

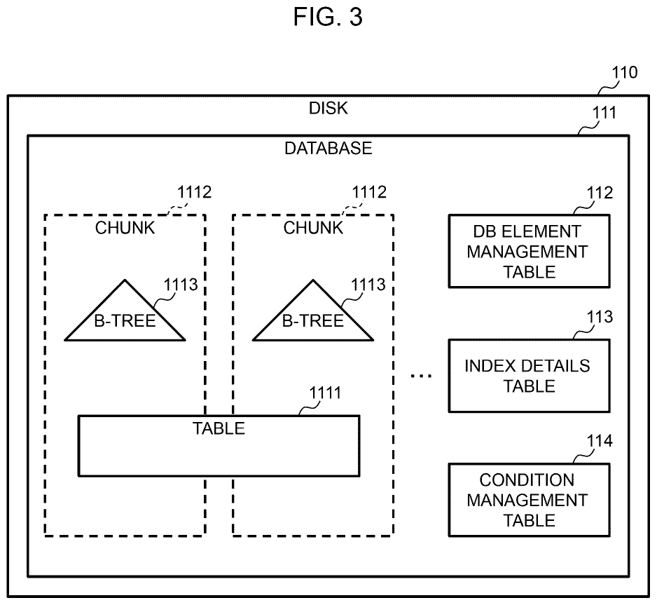

FIG. 3 illustrates a configuration example of the database 111.

The database 111 includes a database table (hereinafter, “DB table”) 1111 over one or more chunks 1112, and a B-tree index (hereinafter, “B-tree”) 113 for each chunk 1112.

The DB table 1111 is a table in which data to be imported is stored. Data imported in the DB table 1111 is hereinafter sometimes referred to as “actual data”. The actual data is managed in association with a pointer of a leaf page (what is called leaf node) of the B-tree 1113. In the database 111, for example, data is imported for every given period of time. Actual data may be what is called Internet of things (IOT) data, or may be processed data, e.g., processed IoT data. For example, actual data may include values observed at a high frequency in a manufacturing line.

The DBMS 1021 (for example, query execution unit 1024) generates a new chunk 1112 each time actual data is imported in the above-mentioned table 1111. For each chunk 1112, a B-tree 1113 is stored by the DBMS 1021 (for example, query execution unit 1024). The B-tree 1113 is configured by one or a plurality of pages, and the plurality of pages include a root page, an intermediate page, and a leaf page. Each leaf page includes a key value and a reference pointer in actual data. Each page in the B-tree 1113 may be called “node”. In the same instance (for example, product), key values may include sequential numbers in addition to an ID of the instance. The sequential numbers may be numbers that are incremented and allocated at each observation change of data. Furthermore, the key value may be included in actual data in addition to a leaf page. The key value may include actual data.

The chunk merge unit 1022 refers to a DB element management table 112, an index details table 113, and a condition management table 114 in chunk merge where a plurality of chunks 1112 are merged to one chunk 1112. Details of the tables 112 to 114 are described later.

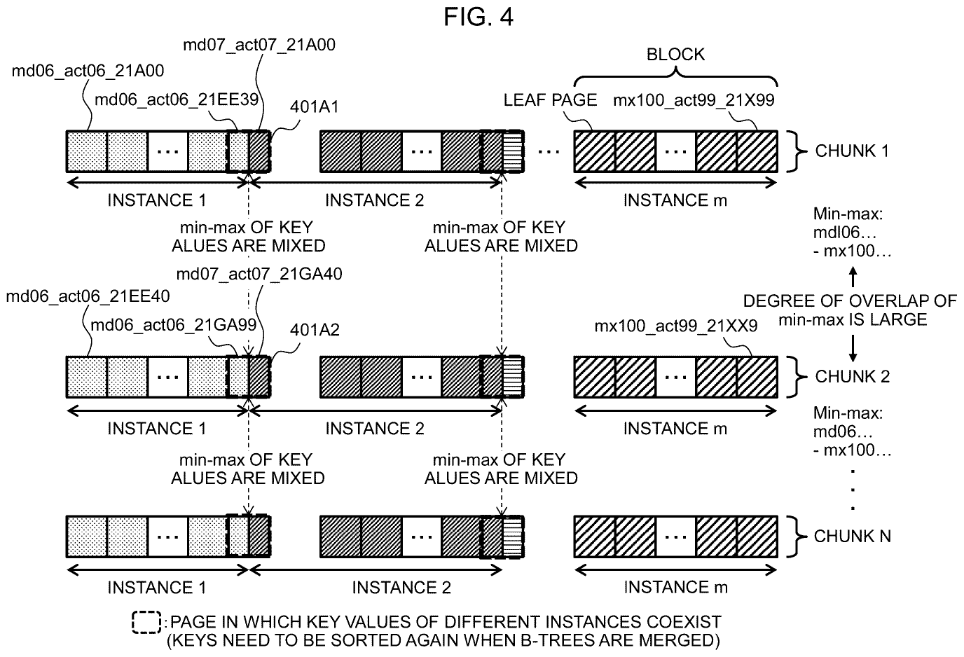

FIG. 4 schematically illustrates the outline of a leaf page with a B-tree index according to the embodiment.

In FIG. 4, in each of chunks 1 to N, a plurality of leaf blocks in a B-tree 1113 of the chunk are illustrated. A “block” is configured by a plurality of pages, and a “leaf block” is configured by a plurality of leaf pages. One leaf block corresponds to one or more instances. In each of leaf pages configuring a leaf block, one or more key values such as “md06_act06_21A00” are stored. Thus, as illustrated in FIG. 4, for example, when an observation timing of data stored in the chunk 1 and an observation timing of data stored in the chunk 2 are different but instances (for example, products) are the same, a part of the key values, specifically, the beginning “md06_act06” is common. The remaining of the key values, that is, sequential numbers are different in the same instance. In each of the plurality of chunks, a plurality of key values for instances 1 to m are stored.

From the viewpoint of units of chunks, the degree of overlapping of min-max values (minimum value and maximum value of key value) is large between chunks (between chunk and next chunk). The reason is that, in each chunk, each instance includes a minimum value and a maximum value of a key value in the chunk. Note that it is assumed that the number of leaf pages in each block is equal among chunks.

On the other hand, from the viewpoint of units of subtrees or units of pages in the B-tree 1113, the number of subtrees or pages where min-max values overlap among chunks is small. In only a part of subtrees (pages), min-max values overlap among chunks. Specifically, in only a part of subtrees (pages), a maximum value of a key value of an instance and a minimum value of a key value of another instance are mixed among chunks. For example, a leaf page 401A1 in the chunk 1 and a leaf page 401A2 in the next chunk 2 each include a maximum value of a key value (key value including “md06_act06”) of the instance 1 and a minimum value of a key value (key value including “md07_act07”) of the instance 2 in regard to the chunks.

In the chunk merge according to the present embodiment, leaf pages including a maximum value of a key value of an instance and a minimum value of a key value of another instance (or subtrees including such leaf pages) are specified as a part that needs to be sorted and reconstructed. Parts other than the specified part does not need to be sorted and reconstructed in chunk merge, and are used for a B-tree 1113 after chunk merge as it is.

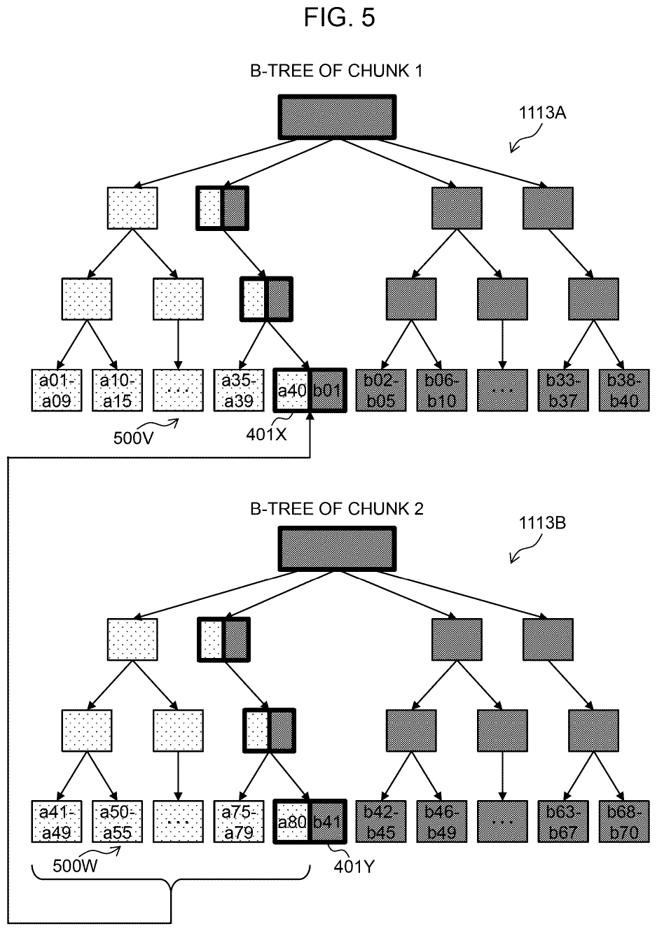

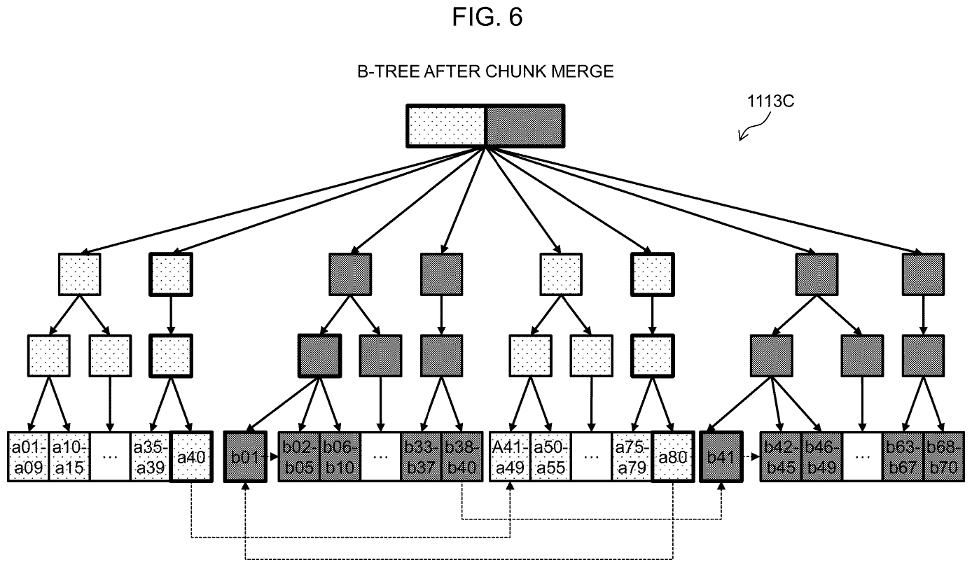

FIG. 5 and FIG. 6 schematically illustrate the outline of chunk merge in the embodiment.

In FIG. 5, a B-tree 1113A of the chunk 1 and a B-tree 1113B of the next chunk 2 are illustrated.

Chunk merge may be performed, for example, in response to an instruction to merge a plurality of chunks. The instruction may be transmitted from the user terminal 10, or may be transmitted from another apparatus or a program. In the instruction, IDs of a plurality of chunks to be merged may be designated. For example, the chunk 1 and the chunk 2 may be designated by the instruction.

Furthermore, chunk merge may be performed in response to merge of DB tables. For example, as a result of merge of DB tables, when the merged DB table is across a plurality of chunks, the plurality of chunks may be recognized as being merge target, and a plurality of B-tree indexes corresponding to the plurality of chunks may be merged.

In the B-tree 1113A, in a leaf page 401X at a right end of a block 500V, key values of different instances, that is, a key value “a40” of a first instance and a key value “b01” of a second instance coexist. In a plurality of pages other than the leaf page 401X at the right end of the block 500V, consecutive key values “a01” to “a39” for the first instance are stored.

Similarly, in the B-tree 1113B, in a leaf page 401Y at a right end of a block 500W, a key value “a80” of the first instance and a key value “b41” of the second instance coexist. In a plurality of pages other than the leaf page 401Y at the right end of the block 500W, consecutive key values “a41” to “a80” for the first instance are stored. In other words, in regard to the first instance, in the chunk 2, the key value “a41”, which is next to the maximum value “a40” of the key value stored in the chunk 1, and the subsequent key values are stored.

The chunk merge unit 1022 specifies the leaf pages 401X and 1113Y including the key values of different instances as a portion where the reconstruction of the B-tree is needed. Furthermore, the chunk merge unit 1022 may specify each of all higher-level page (including root page) of the leaf page 401X in the B-tree 1113A as a portion where the reconstruction of the B-tree is needed. Similarly, the chunk merge unit 1022 may specify each of all higher-level page (including root page) of the leaf page 1113Y in the B-tree 1113B as a portion where the reconstruction of the B-tree is needed. The reason is that higher-level pages of a leaf page including key values of different instances include pointers of different instances such as a pointer to a key value of a first instance and a pointer to a key value of a second instance. In FIG. 5, pages surrounded by thick borders are pages specified as a portion where the reconstruction of the B-tree is needed.

As illustrated in FIG. 5, the chunk merge unit 1022 inserts, at a position between “a40” and “b01” stored in the leaf page 401X of the B-tree 1113A, the key values “a41” to “a80” of the first instance (that is, key values other than key value “b41” of second instance) in the block 500W of the B-tree 1113B.

In the insertion, the chunk merge unit 1022 sorts subtrees to be merged on the basis of the orders of instances and key values as illustrated in FIG. 6. Furthermore, for each page in a subtree subjected to reconstruction, the chunk merge unit 1022 generates or adds a higher-level page in consideration of its key value, or associates (links) with an existing higher-level page, thereby generating a B-tree 1113C after the merge of the B-tree 1113A and the B-tree 1113B. In this manner, the B-tree 1113C corresponding to the merged chunks is generated.

Note that the insertion of the key values “a41” to “a80” in the block 500W of the B-tree 1113B to a position between “a40” and “b01” stored in the leaf page 401X of the B-tree 1113A may be specifically performed as follows, for example. In other words, the insertion may be insertion in a substantial sense rather than insertion in a strict sense.
Generating, from the leaf page 401X having “a40” and “b01” stored therein in the chunk 1, a leaf page that includes “a40” (key value of first instance) and does not include “b01” (key value of second instance) and a leaf page that includes “b01” (key value of second instance) and does not include “a40” (key value of first instance). Specifically, for example, splitting the leaf page 401X having “a40” and “b01” stored therein into a part including “a40” and a part including “b01”. Alternatively, generating a copy of the leaf page 401X, deleting “b01” from the leaf page 401X, and deleting “a40” from the copy of the leaf page 401X.
Similarly, generating, from the leaf page 401Y having “a80” and “b41” stored therein, a leaf page that includes “a80” and does not include “b41” and a leaf page that includes “b41” and does not include “a80”.
Rearranging a link between leaf pages such that key values of a plurality of instances are consecutive in a chunk after merge. Each leaf page has a link (for example, bidirectional link) to a previous leaf page and a link to a subsequent (next) leaf page. According to FIG. 6, for example, the chunk merge unit 1022 sets a link to a leaf page next to the leaf page including “a40” in the chunk 1 as a link to a leaf page including “a41” in the chunk 2. Furthermore, the chunk merge unit 1022 sets a link to a leaf page next to the leaf page including “a80” in the chunk 2 to a link to a leaf page including “b01” in the chunk 1. A link to a leaf page next to the leaf page including “b01” is a link to the leaf page including “b02” in the chunk 1 similarly to the state before merge. The chunk merge unit 1022 sets a link to a leaf page next to the leaf page including “b40” in the chunk 1 (maximum value of key value of second instance in chunk 1) to a link to the leaf page including “b41” in the chunk 2. A link to a leaf page next to the leaf page including “b41” is a link to the leaf page including “b42” in the chunk 2 similarly to the state before merge. In this manner, in the chunk after merge, the key value of the first instance is consecutive from the minimum value to the maximum value and next the key value of the second instance is consecutive from the minimum value to the maximum value. In this manner, the order of key values is maintained even in the chunk after merge.

Details of the chunk merge according to the present embodiment are described.

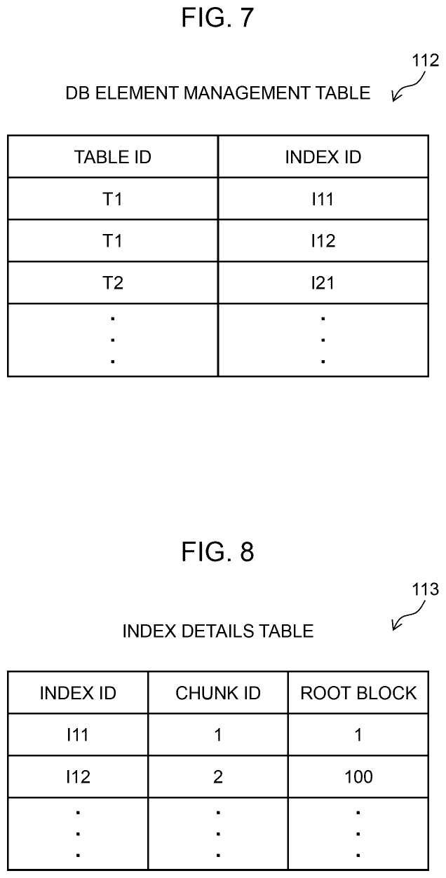

FIG. 7 illustrates a configuration example of the DB element management table 112.

The DB element management table 112 has an entry for each chunk. The entry indicates an ID of a DB table to which actual data stored in a chunk is imported, and an ID of a B-tree index corresponding to the chunk.

FIG. 8 illustrates a configuration example of the index details table 113.

The index details table 113 has an entry for each chunk. The entry indicates an ID of a B-tree index corresponding to a chunk, an ID of the chunk, and an ID of a root block of the B-tree index.

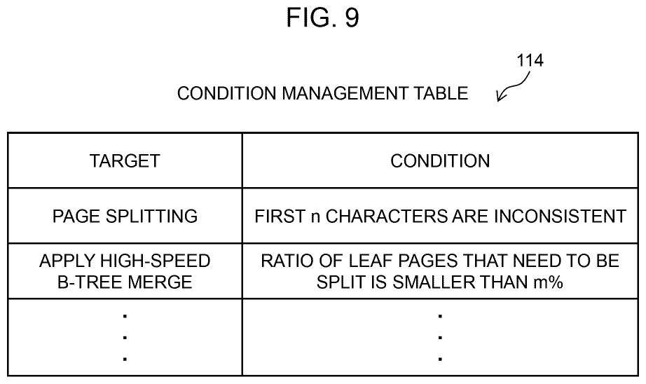

FIG. 9 illustrates a configuration example of the condition management table 114.

The condition management table 114 has an entry for each processing. The entry indicates a condition under which the processing is applied.

For example, when processing is page splitting, examples of a condition for a leaf page to be split include a condition “first n characters are inconsistent”. The value substituted into n may be a value in accordance with the configuration of the key value. Note that “first n characters are inconsistent” corresponds to, in the present embodiment, a condition under which a difference between a maximum value and a minimum value of key values is equal to or larger than a threshold as an example in which key values for different instances coexist, but from another viewpoint, the condition “first n characters are inconsistent” may be a condition under which ranges designated in key values are different as an example in which key values for different instances coexist.

Furthermore, for example, when processing is determination as to whether the chunk merge according to the present embodiment is applicable, examples of a condition for applying chunk merge include a condition “ratio of leaf pages that need to be split is smaller than m %”. The value substituted into m may be a value in accordance with the scale of the B-tree 1113 corresponding to the chunk. Furthermore, the “leaf page that needs to be split” may be typically a leaf page in which key values of different instances coexist. The “ratio of leaf pages that need to be split” is the ratio of the number of “leaf pages that need to be split” to the number of all leaf pages in the B-tree 1113.

A flow of chunk merge is described below. In the present embodiment, as chunk merge, any one of “page unit merge”, which is chunk merge according to a first type, and “subtree unit merge”, which is chunk merge according to a second type, can be employed.

First, page unit merge is described.

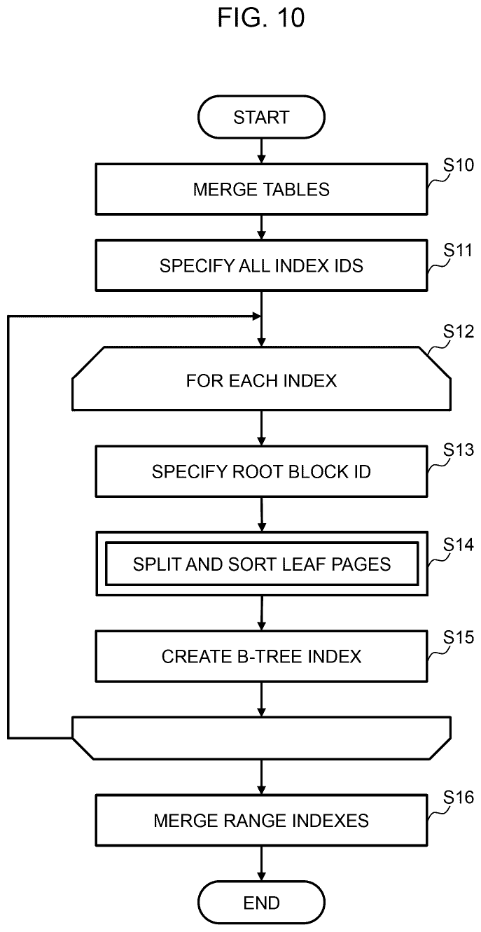

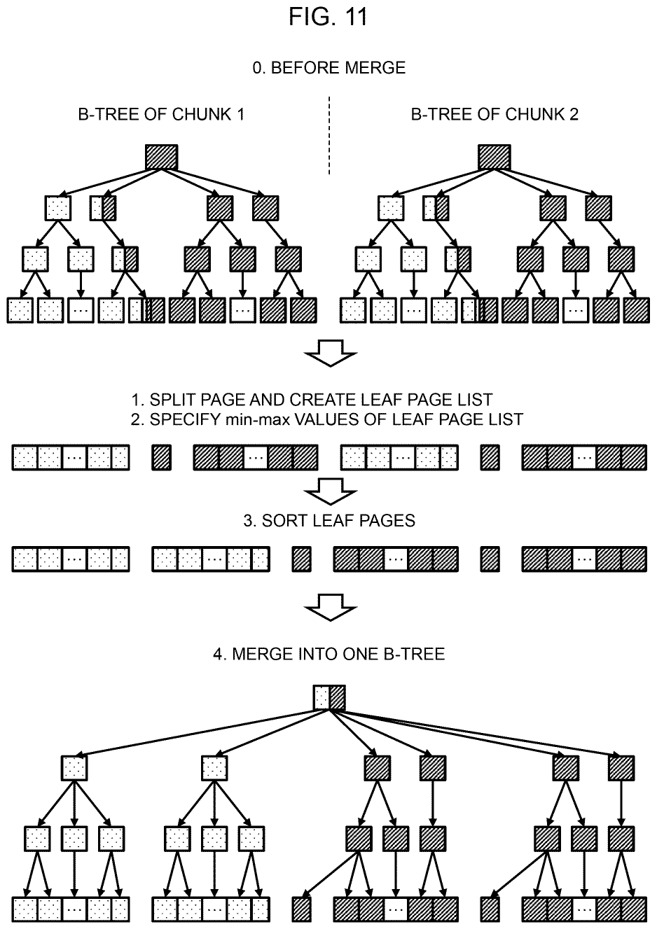

FIG. 10 illustrates a flow example of the page unit merge. FIG. 11 schematically illustrates an example of a situation or processing in a flow of the page unit merge.

The chunk merge unit 1022 executes merge of data in the DB table 1111 (S10). This processing corresponds to, for example, merge of a plurality of DB tables 1111 in the database 111. The merge of these DB tables 1111 (for example, an existing DB table 1111 and a DB table 1111 configured by imported actual data) may be a trigger to execute merge of B-tree indexes of the tables 1111. In this case, the chunk merge unit 1022 may store, in the DB element management table 112, an ID of a table 1111 subjected to merge and an ID of a B-tree index in the table 1111 in association with each other. In the example in FIG. 7, for example, two B-tree indexes “I11” and “I12” exist for a DB table “T1” after merge.

The chunk merge unit 1022 refers to the DB element management table 112 to specify all index IDs subjected to chunk merge (S11). For example, the index IDs “I11” and “I12” corresponding to the DB table “T1” after merge are specified.

Subsequently, the chunk merge unit 1022 repeatedly executes the following processing for each of all index IDs specified at S11 (S12 to S15).

The chunk merge unit 1022 searches the index details table 113 with an index ID as a key, and specifies a root block ID corresponding to the index ID (S13). In this case, as exemplified in FIG. 11, a root block ID is specified for the chunk 1 at S13 for the first index ID, and a root block ID is specified for the chunk 2 at S13 for the second index ID. Furthermore, B-trees in the chunk 1 and the chunk 2 are both subject to page unit merge. Note that a B-tree may have a balanced tree structure in which a root block (root page) is a root node and nodes (blocks or pages) are sequentially branched and forked downward to reach a leaf page (leaf node) at the bottom in accordance with a construction rule of the B-tree index.

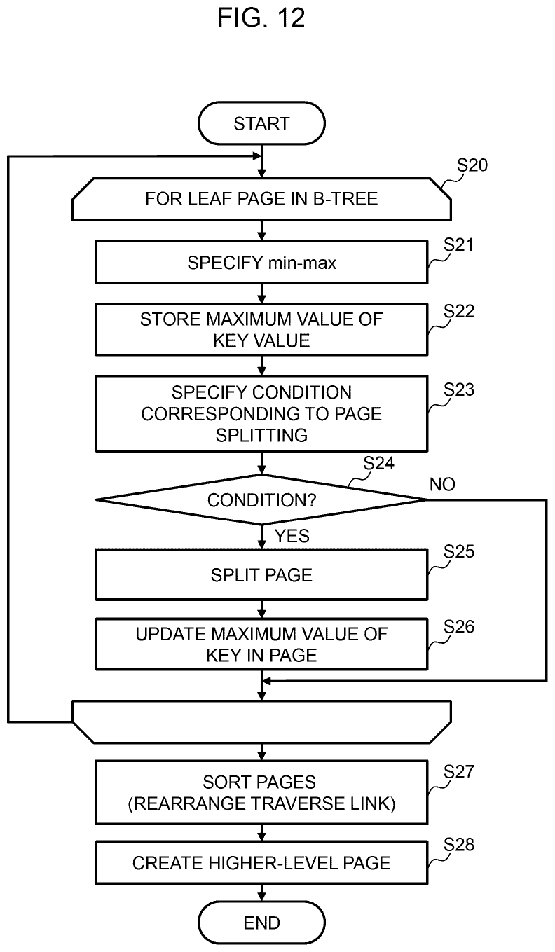

The chunk merge unit 1022 executes splitting and sorting of leaf pages for a B-tree having the root block ID specified at S13 (S14). Details of this processing are described later with reference to FIG. 12.

Subsequently, the chunk merge unit 1022 creates a page at a level higher than the leaf page to a necessary portion in order to maintain the balanced tree structure in response to the loss of the higher-level page due to the splitting and sorting at S14 (S15). The chunk merge unit 1022 executes merge of range indexes, that is, merge of subtrees created up to S15 (S16), and finishes this flow. The example of S15 and S16 is schematically illustrated as “4. Merge into one B-tree” in FIG. 11. Note that the depth of tiers of the B-tree index may be common among all B-tree indexes. It is only necessary that after merge, the depth from a root to a leaf be equal among all leaf pages.

FIG. 12 illustrates a flow example of S14 (splitting and sorting of leaf pages) in FIG. 10.

The chunk merge unit 1022 performs the following processing (S20 to S26) for each leaf page in a B-tree.

The chunk merge unit 1022 specifies a minimum value and a maximum value of a key value in a leaf page (S21). Furthermore, the chunk merge unit 1022 stores the maximum value of the key value in the leaf page in, for example, the memory 102 (S22). S22 is necessary for creating higher-level page at S28 described later. Specifically, the chunk merge unit 1022 stores a set of the key value maximum value stored at S22 and a pointer to the leaf page in the higher-level page at S28 described later.

Subsequently, the chunk merge unit 1022 specifies a condition corresponding to target “page splitting” from the condition management table 114 (S23). In the example in FIG. 9, the condition “first n characters are inconsistent” is specified. Note that the condition corresponding to “page splitting” is a condition for detecting that key values of different instances are mixed in a leaf page, and the condition depends on the configuration of the key value. The condition “first n characters are inconsistent” is, for example, a condition that is employed when key values are the same instance if the first n characters in the key value are the same.

The chunk merge unit 1022 determines, on the basis of the key values specified at S21 and S22, the specified condition obtained at S23 is satisfied (S24). For example, the chunk merge unit 1022 determines whether the first n characters of the maximum value and the first n characters of the minimum value specified at S21 are inconsistent.

When the determination result at S24 is false (S24: NO), the chunk merge unit 1022 finishes the processing (S20 to S26) for the leaf page.

On the other hand, when the determination result at S24 is true (S24: YES), the chunk merge unit 1022 splits the leaf page at a portion where a difference of adjacent key values is equal to or larger than a given value (S25). In a leaf page, when the maximum value of the first instance follows the minimum value of the second instance, the “portion where difference of adjacent key values is equal to or larger than given value” is between the maximum value and the minimum value. Note that, when key values of different N instances (N is an integer of 2 or more) exist in one leaf page, (N−1) portions exit in the leaf page as portions where a maximum value of an instance follows a minimum value of another instance. Thus, the (N−1) portions are splitting portions, and as a result, one leaf page is split into N leaf pages.

Furthermore, the chunk merge unit 1022 updates, for each of new leaf pages generated by the splitting at S25, a maximum value of a key value in the leaf page (S26). Specifically, in each of new leaf pages, the maximum value of the key value is a maximum value of a key value for an instance corresponding to the leaf page. In this manner, the maximum value of the key value of the page has been changed because the page has been split, and S26 is processing for updating the maximum value of the key value.

After the above-mentioned processing (S20 to S26) has been performed for each leaf page, the chunk merge unit 1022 uses maximum values of key values in leaf pages to sort the leaf pages (S27) for a plurality of chunks to be merged (for example, chunk 1 and chunk 2). In this case, the chunk merge unit 1022 executes the rearrangement of transverse links (links between leaf pages).

Furthermore, the chunk merge unit 1022 creates a higher-level page in accordance with a construction rule of B-tree index to a higher-level of a leaf page where a higher-level page has been temporarily lost due to the page splitting in routine in order to maintain a balanced tree structure in consideration of the magnitudes of key values in other leaf pages (S28).

The above is the description of page unit merge. Note that “1. Split page and create leaf page list” exemplified in FIG. 11 corresponds to the specification of each leaf page in the flow illustrated in FIG. 12. Furthermore, “2. Specify min-max values of leaf page list” exemplified in FIG. 11 corresponds to S21 and S26 in the flow illustrated in FIG. 12. Furthermore, “3. Sort leaf pages” exemplified in FIG. 11 corresponds to S27 in the flow illustrated in FIG. 12.

Next, subtree unit merge is described.

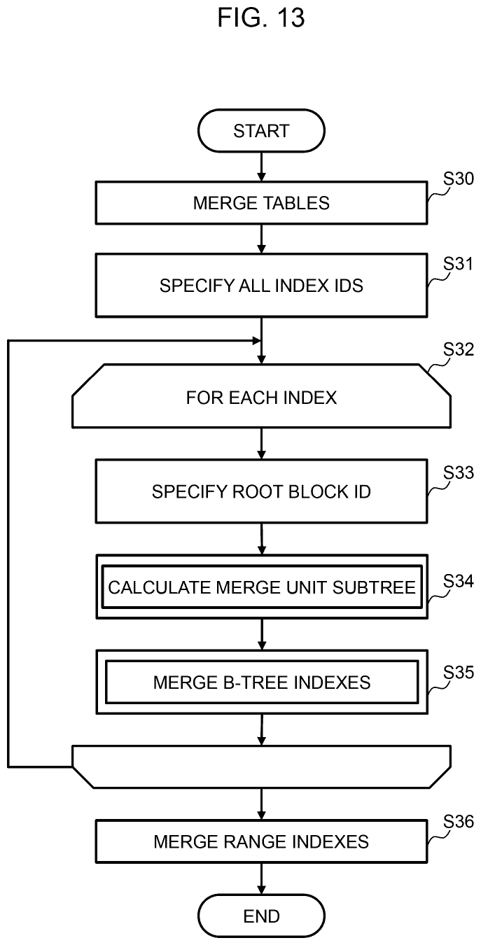

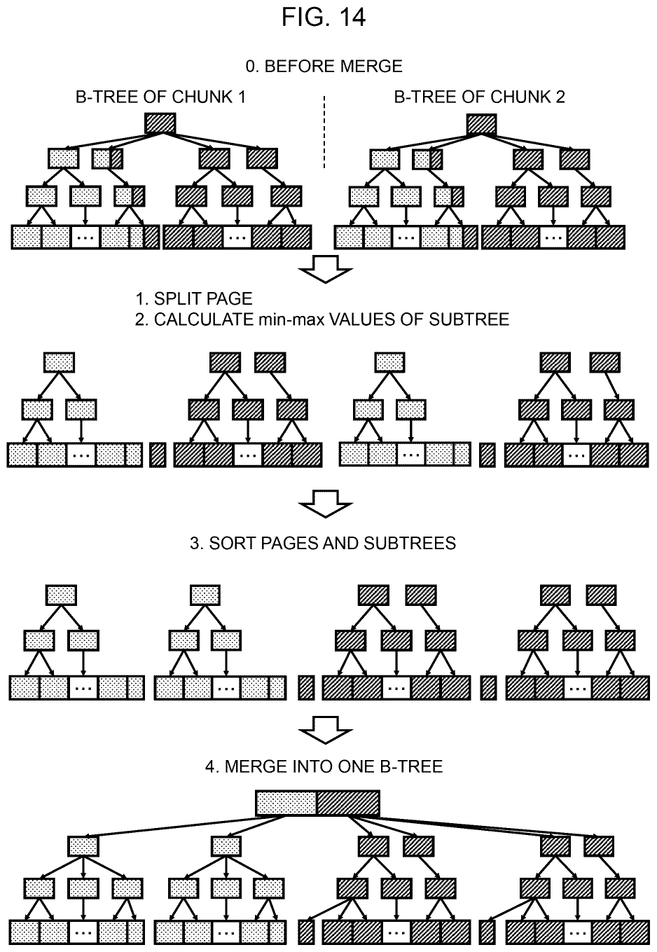

FIG. 13 illustrates a flow example of subtree unit merge. FIG. 14 schematically illustrates an example of a situation or processing in a flow of subtree unit merge. Note that S30 to S31 and S32 to S33 and S36 in this flow are identical or similar to S10 to S11 and S12 to S13 and S16 in FIG. 10, and hence descriptions thereof are omitted.

The chunk merge unit 1022 executes the following processing of S33 to S35 for each B-tree index defined in the DB element management table 112. Of those, at S34, the chunk merge unit 1022 executes calculation of a merge unit subtree on the basis of a root block ID specified at S33 (S34).

FIG. 13 illustrates a flow example of S34.

The chunk merge unit 1022 executes the following processing (S41 to S45) for a higher-level page in a B-tree index (each page at level higher than leaf page) (S40).

The chunk merge unit 1022 specifies a minimum value and a maximum value of a key value in a higher-level page to be processed (S41). The chunk merge unit 1022 specifies a condition corresponding to target “page splitting” from the condition management table 114 (S42). The chunk merge unit 1022 determines whether the key value specified at S41 satisfies the condition specified at S42 (S43).

When the determination result at S43 is false (S43: NO), the chunk merge unit 1022 finishes the processing (S41 to S45) for the higher-level page.

On the other hand, when the determination result at S43 is true (S43: YES), the chunk merge unit 1022 determines whether a page at a level higher than the higher-level page (hereinafter, “target higher-level page”) also satisfies the condition specified at S42 (S44).

When the determination result at S44 is true (S44: YES), the chunk merge unit 1022 finishes the processing (S41 to S45) for the target higher-level page.

On the other hand, when the determination result at S44 is false (S44: NO), the chunk merge unit 1022 stores information on the target higher-level page in the memory 102 (S45), and finishes the processing (S41 to S45) for the target higher-level page.

After the processing (S40 to S45) for each higher-level page, the chunk merge unit 1022 executes the following processing (S46 to S54) for each page stored in the memory 102 at S45.

First, the chunk merge unit 1022 determines whether the page (hereinafter, “target page”) stored at S45 is one level higher than a leaf page (S47). When the determination result at S47 is false (S47: NO), the chunk merge unit 1022 sets a subtree in which a page pointed by a target page is a vertex as a merge unit subtree (S48).

When the determination result at S47 is true (S47: YES), the chunk merge unit 1022 executes the following processing (S49 to S54) for each of one or more leaf pages at a level lower than the target page.

The chunk merge unit 1022 specifies a minimum value and a maximum value of a key value in the leaf page (hereinafter, “target leaf page”) (S50). The chunk merge unit 1022 specifies a condition corresponding to target “page splitting” from the condition management table 114 (S51). The chunk merge unit 1022 determines whether the key value specified at S50 satisfies the condition specified at S51 (S52).

When the determination result at S52 is false (S52: NO), the chunk merge unit 1022 sets the target leaf page as a merge unit subtree (S54).

On the other hand, when the determination result at S52 is true (S52: YES), the chunk merge unit 1022 splits the target leaf page at a portion where a difference of adjacent key values is equal to or larger than a given value (S53). The chunk merge unit 1022 sets each leaf page obtained by the splitting as a merge unit subtree (S54).

When the above-mentioned processing of S47 to S54 is executed for each page stored at S45, the chunk merge unit 1022 finishes this flow.

After the calculation of the merge unit subtree (S34 in FIG. 13) has been finished, the chunk merge unit 1022 executes merge of B-tree indexes (S35 in FIG. 13).

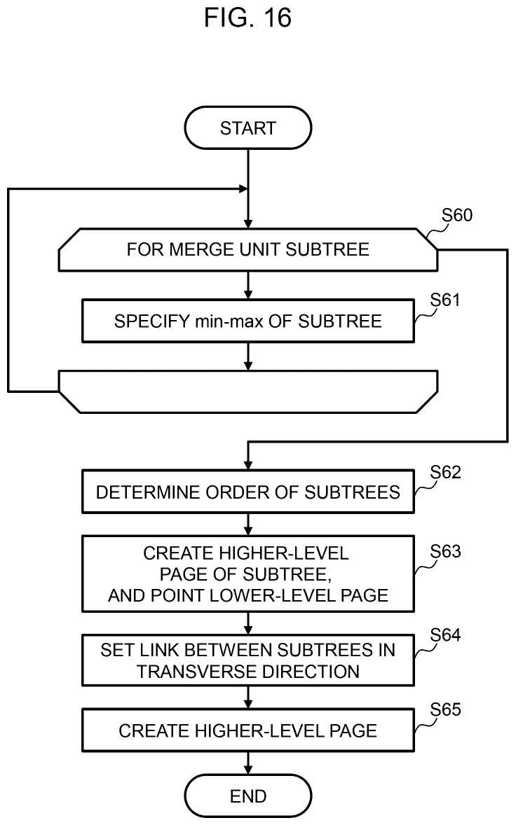

FIG. 16 illustrates a flow example of S35 in FIG. 13.

The chunk merge unit 1022 executes processing (S60 and S61) for each merge unit subtree. In other words, the chunk merge unit 1022 specifies a minimum value and a maximum value of a subtree (S61).

After that, the chunk merge unit 1022 determines the order of subtrees (S62). The order of subtrees follows the magnitudes of key values on the basis of the minimum value and the maximum value specified at S61.

In regard to the subtrees whose order has been determined at S62, the chunk merge unit 1022 creates higher-level pages thereof as necessary, and points lower-level pages (S63).

Subsequently, the chunk merge unit 1022 sets a link between subtrees in a transverse direction (S64). Furthermore, the chunk merge unit 1022 creates higher-level page (S65), and finishes this flow.

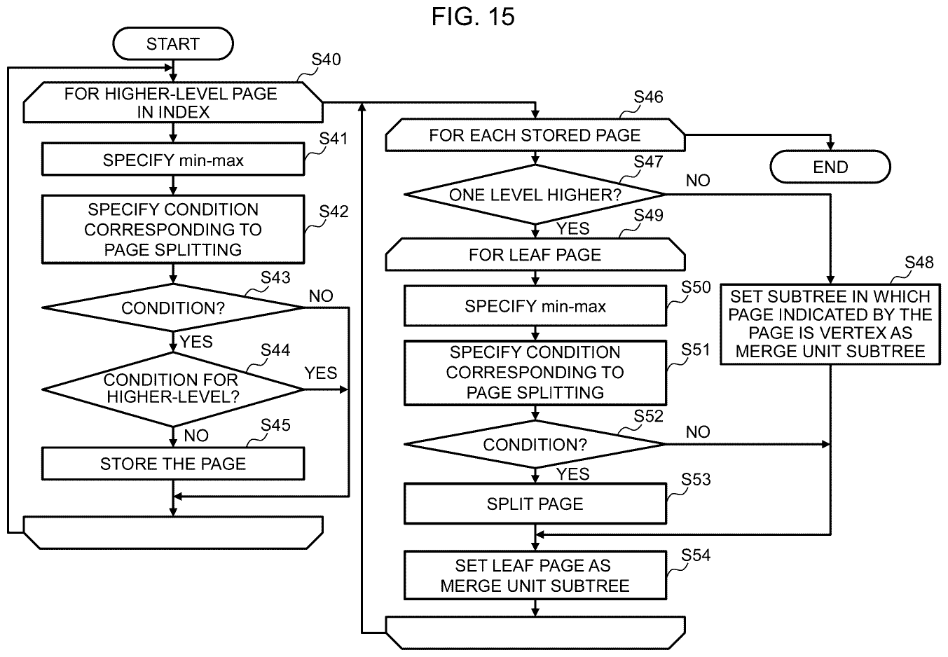

The above is the description of subtree unit merge. Note that “1. Split page” exemplified in FIG. 14 corresponds to S53 in the flow illustrated in FIG. 15. Furthermore, “2. Specify min-max values of subtree” exemplified in FIG. 14 corresponds to S61 in the flow illustrated in FIG. 16. Furthermore, “3. Sort pages and subtrees” exemplified in FIG. 14 corresponds to S62 to S64 in the flow illustrated in FIG. 16. Furthermore, “4. Merge to one B-tree” exemplified in FIG. 14 corresponds to S65 in the flow illustrated in FIG. 16.

The above is the description of subtree unit merge.

Note that which of the page unit merge and the subtree unit merge is employed may be determined in advance in a design stage of the chunk merge unit 1022. In other words, the chunk merge unit 1022 may be designed such that the page unit merge is performed but the subtree unit merge cannot be performed, and the chunk merge unit 1022 may be designed such that the subtree unit merge is performed but the page unit merge cannot be performed.

Furthermore, the chunk merge unit 1022 may be designed such that both the page unit merge and the subtree unit merge can be performed. Furthermore, the chunk merge unit 1022 may dynamically determine which of the page unit merge and the subtree unit merge is performed. Regardless of whether which of the page unit merge and the subtree unit merge is performed has been determined in advance or determined dynamically, it is preferred that page unit merge be performed when the number of leaf pages to be split is large and the subtree unit page be performed when the number of leaf pages to be split is small. Whether the number of leaf pages to be split is “large” or “small” may be whether the number of leaf pages to be split is equal to or larger than a threshold. The threshold may be determined in advance depending on the scale of the database 111 or determined dynamically by the chunk merge unit 1022.

Furthermore, the page unit merge described above with reference to FIG. 10 to FIG. 12 and the subtree unit merge described above with reference to FIG. 13 to FIG. 16 are each an example of the chunk merge according to the present embodiment, but as described later, page unit merge according to a modification and subtree unit merge according to a modification are conceivable. In both modifications, merge of B-tree indexes includes determination as to whether high-speed B-tree merge (merge where sorting of key values is required in part of pages) or normal B-tree merge (merge where sorting of key values is required in all pages) is performed.

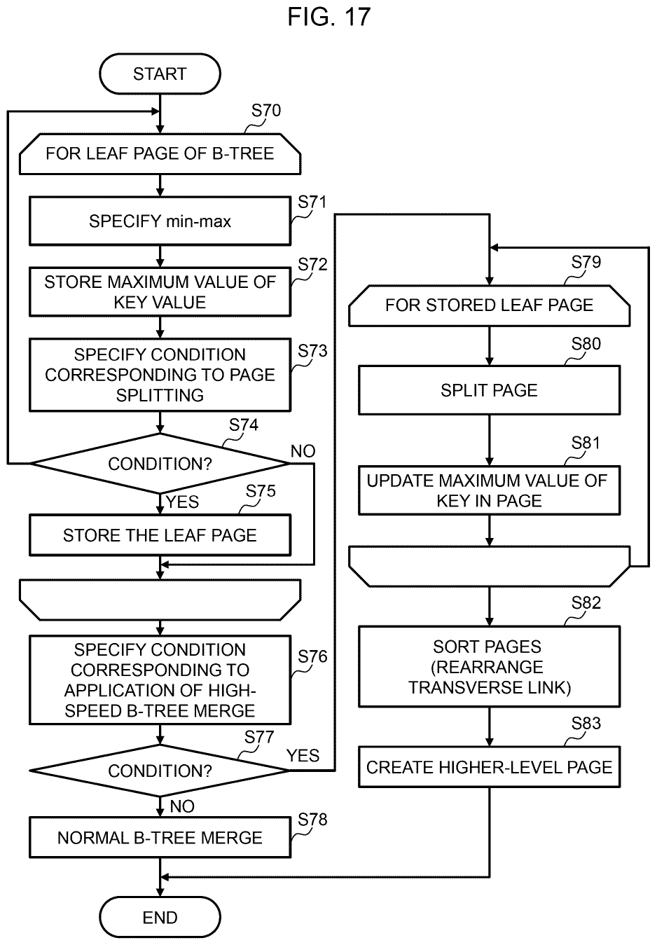

FIG. 17 illustrates a flow example of page unit merge according to the modification.

The chunk merge unit 1022 executes the processing (S70 to S75) for each leaf page in a B-tree. In the processing (S70 to S75), S70 to S74 are the same processing as S20 to S24 illustrated in FIG. 12, and hence descriptions thereof are omitted.

When the determination result at S74 is true (S74: YES), in other words, when the leaf page satisfies a condition corresponding to page splitting, the chunk merge unit 1022 stores the leaf page in, for example, the memory 102 (S75).

After the processing (S70 to S75) for each leaf page, the chunk merge unit 1022 specifies a condition corresponding to target “application of high-speed B-tree merge” from the condition management table 114 (S76). In the example illustrated in FIG. 9, “ratio of leaf pages that need to be split is smaller than m %” is specified. A freely selected value is set to m.

The chunk merge unit 1022 determines whether the condition is satisfied (S77). In this case, the chunk merge unit 1022 calculates the ratio of the number of leaf pages stored at S75 to all leaf pages in the B-tree, and determines whether the ratio is smaller than mo.

When the determination result at S77 is false (S77: NO), the chunk merge unit 1022 executes normal B-tree merge that does not involve leaf page splitting (S78).

On the other hand, when the determination result at S77 is true (S77: YES), the chunk merge unit 1022 executes the processing (S79 to S81) for each leaf page stored at S75. Note that S80 to S81 and subsequent S82 to S83 are identical or similar to S25 to S26 and S27 to S28 illustrated in FIG. 12, and hence descriptions thereof are omitted.

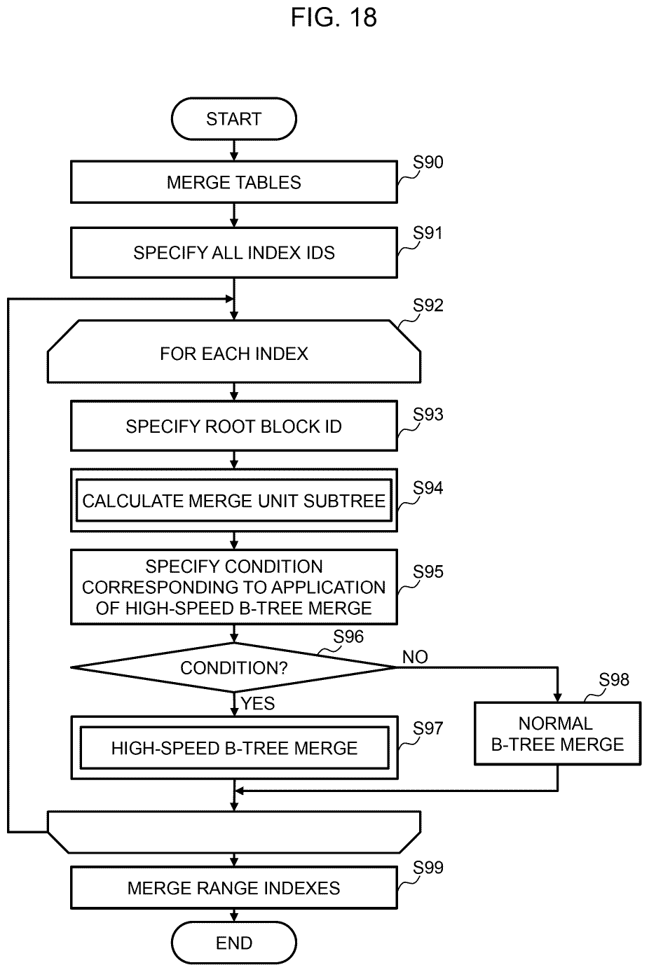

FIG. 18 illustrates a flow example of subtree unit merge according to a modification.

S90 to S94, S97, and S99 in this flow are the same processing as S30 to S34, S35, and S36 in the flow illustrated in FIG. 13, and hence descriptions thereof are omitted.

The chunk merge unit 1022 specifies a condition corresponding to target “application of high-speed B-tree merge” from the condition management table 114 (S95). The chunk merge unit 1022 determines whether the condition is satisfied (S96).

When the determination result at S96 is false (S96: NO), the chunk merge unit 1022 executes normal B-tree merge (S98).

On the other hand, when the determination result at S96 is true (S96: YES), the chunk merge unit 1022 executes high-speed B-tree merge (S97).

After the processing (S92 to S98) has been completed for each B-tree index, the chunk merge unit 1022 executes merge of range indexes (S99).

The above is chunk merge according to the modification.

While one embodiment and some modifications have been described above, these are illustrative to describe the present invention, and are not intended to limit the scope of the present invention only to the embodiment or modifications. The present invention can be implemented in other various forms.

Furthermore, the above description can be summarized as follows. The following summary may include supplemental description of the above description and description of the modifications.

A database management apparatus (for example, database management apparatus 100) includes a query execution unit (for example, query execution unit 1024) and a chunk merge unit (for example, chunk merge unit 1022). The query execution unit may be provided to an apparatus outside the database management apparatus.

For every import of data to a database, in response to a query of the import, the query execution unit stores data to be imported in a chunk (for example, chunk 1112) corresponding to the import, thereby constructing a B-tree index (for example, B-tree 1113) corresponding to the chunk.

For each chunk, a B-tree index corresponding to the chunk is an index having a tree structure with a plurality of pages as a plurality of nodes, and includes one or a plurality of key values as one or a plurality of values for each of a plurality of instances. For example, for each chunk, at least all leaf pages in a B-tree index include one or a plurality of key values for each of a plurality of instances. In each leaf page, each of a part of or all of higher-level pages of the leaf page may have all key values included in a leaf page that is directly or indirectly associated with the higher-level page (or summary of leaf page). The “summary of leaf page” may be minimum values and maximum values of all the key values. For example, each higher-level page may include, for each lower-level page at a level lower than the higher-level page, as a summary of the lower-level page, a maximum value of a key value in the lower-level page. Depending on a relation between a key value to be retrieved and a maximum value, a lower-level page to be referenced may be determined.

The chunk merge unit specifies, for each of a plurality of chunks to be merged, one or more pages that satisfy a condition under which a page includes key values of different instances, the one or more pages being a part of pages in a B-tree index corresponding to the chunk. The chunk merge unit splits, for each of the one or more specified pages, the page into a page that includes a maximum value of a key value for an instance and a page that includes a minimum value of a key value for another instance. The chunk merge unit sorts a plurality of pages including pages obtained by splitting each of one or more pages in accordance with the magnitudes of a plurality of key values of a plurality of instances. The sorting may be substantial sorting of pages, for example, rearrangement of links between pages. The chunk merge unit constructs one B-tree index including sorted pages as a B-tree index after merge of a plurality of B-tree indexes corresponding to a plurality of chunks to be merged.

In this manner, the number of pages for each key values need to be recreated and the necessity of migration (copy) of data can be minimized, and hence processing load necessary for index merge of B-tree indexes can be reduced.

For each instance, a key value corresponding to the instance may be a value that becomes larger as a time point at which the key value is obtained for the instance is later. For example, when a key value includes an ID of an instance, the ID itself may be a value that becomes larger for an instance where a time point at which the key value is obtained is later. Specifically, for example, for every import, when there are a plurality of key values of a plurality of different instances, in the import, the order by which consecutive key values of an instance follow consecutive key values of another instance may be employed.

The chunk merge unit may perform the following.
(11-a1) To specify, for each of a plurality of chunks to be merged, as one or more pages, one or more leaf pages for which a difference between maximum values and minimum values of key values is equal to or larger than a threshold.
(11-a2) To store, for each of the one or more specified leaf pages, the maximum value of the key value for the leaf page in, for example, a memory.
(11-b) To split, for each of the one or more specified leaf pages, the leaf page that satisfies a condition, under which a leaf page includes key values of different instances, into a leaf page that includes a maximum value of a key value for an instance and a leaf page that includes a minimum value of a key value for another instance, and store a maximum value of a key value for each of the split leaf pages in, for example, a memory.
(12-a) To sort leaf pages including leaf pages obtained by splitting each of one or more leaf pages. For example, for each of the split leaf pages, a link destination of the leaf page is set to a leaf page in which a key value next to the maximum value of the leaf page is a minimum value.
(12-b1) To create a higher-level page having one or a plurality of tiers for all leaf pages including the sorted leaf pages.
(12-b2) To construct one B-tree index including the sorted leaf pages and the created higher-level page as a B-tree index after merge of a plurality of B-tree indexes corresponding to a plurality of chunks to be merged.

In this manner, a splitting position of a B-tree index can be determined in units of leaf pages, and merge into one B-tree index can be performed. Note that an example of the condition under which a page includes key values of different instances may be a condition under which a difference between a maximum value and a minimum value of key values is equal to or larger than a threshold. In this case, 1, and 2. illustrated in FIG. 11 may correspond to (11-a1), (11-a2), and (11-b). 3. illustrated in FIG. 11 may correspond to (12-a). 4. illustrated in FIG. 11 may correspond to (12-b1) and (12-b2).

The chunk merge unit may perform the following.
(21-a) To specify, for each of a plurality of chunks to be merged, a higher-level page that satisfies a condition under which a page includes key values of different instances.
(21-b) To specify, when the higher-level page specified in (21-a) is a higher-level page that is one level higher than a leaf page, a leaf page that satisfies a condition under which a page includes key values of different instances from among leaf pages of the higher-level page, split the specified leaf page into a leaf page that includes a maximum value of a key value for an instance and a leaf page that includes a minimum value of a key value for another instance, and sets a leaf page pointed by the higher-level page specified in (21-a) and the split leaf pages as subtrees in units of merge.
(21-c) To set, when the specified higher-level page is not a higher-level page that is one level higher than a leaf page, a subtree in which a page pointed by the higher-level page is a vertex as a subtree in units of merge.
(22-a) To specify a minimum value and a maximum value of a key value for each subtree in units of merge.
(22-b) To sort a plurality of subtrees in units of merge in accordance with the magnitudes of key values.
(22-c) To create a higher-level page in accordance with a minimum value and a maximum value of each subtree in units of merge, and construct one B-tree index including the sorted subtrees and the created higher-level page as a B-tree index after merge of a plurality of B-tree indexes corresponding to a plurality of chunks to be merged.

In this manner, a splitting position of a B-tree index can be determined in units of subtrees, and merge into one B-tree index can be performed. Note that an example of the condition under which a page includes key values of different instances may be a condition under which a difference between a maximum value and a minimum value of key values is equal to or larger than a threshold. In this case, 1, and 2. illustrated in FIG. 14 may correspond to (21-a), (21-b), (21-c), and (22-a). 3. illustrated in FIG. 14 may correspond to (22-b). 4. illustrated in FIG. 14 may correspond to (22-c).

The sorting of leaf pages may be the updating of links between leaf pages. In other words, for example, the chunk merge unit may sort leaf pages or the subtrees in such a manner that a pointer (link destination) set between leaf pages is updated to avoid the movement of physical storage positions of leaf pages. In this manner, migration (copy) of data can be avoided.

A page that satisfies a condition under which a page includes key values of different instances may be any one of the following. Which of the conditions is employed may be determined depending on the configuration of the key value.
A page where two or more key values with different ranges designated by key values exist.
A page where a difference between a maximum value and a minimum value of key values is equal to or larger than a threshold.

The range (for example, value substituted into n exemplified in FIG. 9) or the threshold in the conditions may be a value set from the outside (for example, user terminal 10). For example, the chunk merge unit may receive, in regard to the threshold, an instruction from a predetermined terminal, specify a splitting position of a leaf page or a subtree on the basis of a threshold indicated by the received instruction, and execute splitting. In this manner, a splitting position in a database subjected to chunk merge can be precisely determined by a condition designated by a user, for example, in consideration of the specific form of data (for example, digit number, appearance position of identification information specific to DB operation task). Note that the range or the threshold in the condition corresponding to target “page splitting” may differ depending on a tier in a B-tree index, such as whether the page is a leaf page or a higher-level page in any tier.

The chunk merge unit may calculate, for each of a plurality of chunks to be merged, a proportion of the number of leaf pages that satisfy a condition under which a leaf page includes key values of different instances (for example, number of leaf pages in which difference between minimum value and maximum value of key value is equal to or larger than threshold) to the number of all leaf pages in a B-tree index corresponding to the chunk, and execute processing including the above-mentioned splitting and sorting when the proportion is smaller than a threshold of the proportion. In this manner, when processing load necessary for a series of processing including splitting and sorting of leaf pages and creation of higher-level pages may be equal to or higher than processing load for conventional B-tree index merge, the execution of the series of processing can be avoided to avoid processing load from increasing. Note that the threshold of the proportion may be set from the outside.

Note that, in the same instance, a key value may be typically a value that becomes larger as a time point at which a value included in the key value for the instance is obtained is later. Furthermore, in different instances, when time points at which values included in key values are obtained are identical or similar, the relation of the magnitudes of key values may be determined by IDs of the instances. Furthermore, the instance may vary depending on environments and types of businesses where a database is used. For example, when a database is used in a manufacturing industry, an instance may be a product, a material, a facility, or an operator. Furthermore, when a database is used in a healthcare business, an instance may be a subject or a device worn by a subject. Furthermore, when a database is used in a retail business, an instance may be an order or its details.

What is claimed is:

1. A database management apparatus, comprising a query execution unit and a chunk merge unit, wherein
the query execution unit stores, for every import of data to a database, in response to a query of the import, data to be imported in a chunk corresponding to the import, and constructs a B-tree index corresponding to the chunk;
for each chunk, the B-tree index corresponding to the chunk is an index having a tree structure in which a plurality of pages are a plurality of nodes, and includes one or a plurality of key values as one or a plurality of values for each of a plurality of instances;
for each instance, a key value corresponding to the instance is a value that becomes larger as a time point, at which the key value is obtained for the instance, is later; and
the chunk merge unit is configured to:
(a) specify, for each of a plurality of chunks to be merged, one or more pages that satisfy a condition under which a page includes key values of different instances, the one or more pages being a part of pages in a B-tree index corresponding to the chunk;
(b) split, for each of the one or more specified pages, the page into a page that includes a maximum value of a key value for an instance and a page that includes a minimum value of a key value for another instance;
(c) sort a plurality of pages including pages obtained by splitting each of the one or more pages in accordance with magnitudes of key values; and
(d) construct, as a B-tree index after merge of a plurality of B-tree indexes corresponding to the plurality of chunks to be merged, one B-tree index including the sorted pages.

2. The database management apparatus according to claim 1, wherein the chunk merge unit is configured to:
specify, for each of the plurality of chunks to be merged, as the one or more pages, one or more leaf pages in which a difference between a maximum value and a minimum value of a key value is equal to or larger than a threshold;
store, for each of the one or more specified leaf pages, a maximum value of a key value in the leaf page;
split, for each of the one or more specified leaf pages, the leaf page that satisfies a condition under which the leaf page includes key values of different instances into a leaf page that includes a maximum value of a key value for an instance and a leaf page that includes a minimum value of a key value for another instance, and store a maximum value of a key value for each leaf page after splitting;
sort leaf pages including leaf pages obtained by splitting each of the one or more leaf pages;
create a higher-level page having one or a plurality of tiers for all leaf pages including the sorted leaf pages; and
construct, as a B-tree index after merge of a plurality of B-tree indexes corresponding to the plurality of chunks to be merged, one B-tree index including the sorted leaf pages and the created higher-level page.

3. The database management apparatus according to claim 1, wherein the chunk merge unit is configured to:
specify, for each of the plurality of chunks to be merged, a higher-level page that satisfies a condition under which the higher-level page includes key values of different instances;
when the specified higher-level page is a higher-level page that is one level higher than a leaf page, specify a leaf page that satisfies a condition under which a page includes key values of different instances from among leaf pages of the higher-level page, split the specified leaf page into a leaf page that includes a maximum value of a key value for an instance and a leaf page that includes a minimum value of a key value for another instance, and set a leaf page pointed by the higher-level page and the split leaf pages as subtrees in units of merge, respectively;
when the specified higher-level page is not a higher-level page that is one level higher than a leaf page, set a subtree, in which a page pointed by the higher-level page is a vertex, as a subtree in units of merge;
specify, for each subtree in units of merge, a minimum value and a maximum value of key values;
sort a plurality of subtrees in units of merge in accordance with magnitudes of key values;
create a higher-level page in accordance with the minimum value and the maximum value for each subtree in units of merge; and
construct one B-tree index including the sorted subtrees and the created higher-level page as a B-tree index after merge of a plurality of B-tree indexes corresponding to the plurality of chunks to be merged.

4. The database management apparatus according to claim 1, wherein the sorting of leaf pages comprises updating of a link between leaf pages.

5. The database management apparatus according to claim 1, wherein the page that satisfies the condition under which the page includes key values of different instances is any of followings:
a page where two or more key values with different designated ranges in the key values exist; and
a page where a difference between a maximum value and a minimum value of key values is equal to or larger than a threshold.

6. The database management apparatus according to claim 5, wherein the range or the threshold comprises a range or a threshold set from outside.

7. The database management apparatus according to claim 1, wherein the chunk merge unit calculates, for each of the plurality of chunks to be merged, a proportion of the number of leaf pages that satisfy a condition under which a page includes key values of different instances to the number of all leaf pages included in a B-tree index corresponding to the chunk, and performs the (b) to (d) when the proportion is smaller than a threshold of the proportion.

8. The database management apparatus according to claim 7, wherein the threshold of the proportion comprises a value set from outside.

9. A database management method for causing a computer to execute:
specifying, for each of a plurality of chunks to be merged among a plurality of chunks in a database, one or more pages in which a difference between a maximum value and a minimum value of key values is equal to or larger than a threshold, the one or more pages being a part of pages in a B-tree index corresponding to the chunk,
wherein, for every import of data to the database, a chunk corresponding to the import has data to be imported and a B-tree index corresponding to the chunk,
wherein, for each chunk, the B-tree index corresponding to the chunk includes one or a plurality of key values as one or a plurality of values for each of a plurality of instances,
wherein, in each instance, a key value corresponding to the instance is a value that becomes larger as a time point at which the key value is obtained for the instance is later,
the method further comprising:
splitting, for each of the one or more specified pages, the page including a maximum value and a minimum value of key values into a page that includes a maximum value of a key value and a page that includes a minimum value of a key value;
sorting a plurality of pages including pages obtained by splitting each of the one or more pages in accordance with magnitudes of a plurality of key values of the plurality of instances; and
constructing one B-tree index including the sorted pages as a B-tree index after merge of a plurality of B-tree indexes corresponding to the plurality of chunks to be merged.
